(19) United States
(12) Patent Application Publication
(10) Pub. No.: US 2014/0091929 A1
(43) Pub. Date: Apr. 3, 2014

(54) Systems and Methods for Secure Alarmed Armored Protective Distribution Systems and Management

(71) Applicant: Network Integrity Systems, Inc., Hickory, NC (US)

(72) Inventors: Cary Murphy, Hickory, NC (US); Mark K. Bridges, Hickory, NC (US); Joseph Giovannini, Hickory, NC (US); David E Vokey, Sidney (CA); David J Thompson, Hickory, NC (US); Robert J Murphy, Hickory, NC (US)

(21) Appl. No.: 13/632,728

(22) Filed: Oct. 1, 2012

(51) Int. Cl. G08B 13/186

(52) U.S. Cl. CPC G08B 13/186
USPC 340/541

(57) ABSTRACT

A fiber optic network has alarmed fiber optic lines in the cables connecting a secured junction box to plural user lock boxes. An outgoing alarm line and return alarm line in each cable connect the junction box to each user box. The outgoing alarm line is looped to the return alarm line inside the user lock box. The return alarm line is looped to the outgoing alarm line of a different cable inside the junction box to interconnect a plurality of alarm lines passing through a plurality of user boxes. A detector detects an alarm signal in the connected alarm lines to trigger an intrusion alarm.

### BACKGROUND OF THE INVENTION

Reference is made to the following patents which may be related to this matter, the disclosures of each of which are incorporated herein by reference:

U.S. Pat. No. 8,233,755 Jul. 31 2012

U.S. Pat. No. 8,094,977 Jan. 10 2012

U.S. Pat. No. 7,693,359 Apr. 6 2010

U.S. Pat. No. 7,706,641 Apr. 27 2010

U.S. Pat. No. 7,634,387 Dec. 15 2009

U.S. Pat. No. 7,403,675 Jul. 22 2008

U.S. Pat. No. 7,376,293 May 20 2008

U.S. Pat. No. 7,206,469 Apr. 17 2007

U.S. Pat. No. 7,120,324 Oct. 10 2006

Data is sent to computers or sent among computers by electromagnetic transmission through the air (e.g., laser or Wi-Fi), or is sent through wires (typically copper or aluminum), or is sent by fiber optic cables. The transmitted data must be protected in order to guard against intruders intercepting data as it is transmitted. The transmitted data may be encrypted, but encryption impedes potential use of the data and does not restrain the interception of the data in the first place. Encryption also requires time and equipment to encrypt the data, and to decrypt the data, thus increasing expense and causing delays in transmitting and using the data. Since data transmitted over the airways is subject to interception, data transmission over wires or optical cables provides improved resistance to interception.

There is thus a need for an improved way to monitor data transmission between computers or to computers. The U.S. Government need for security and the related development of SIPRNET, JWICS and other secure networks reflects this need for improved ways to prevent data interception or to monitor data to give an alarm when attempts are being made to intercept the transmitted data.

Protective distribution systems are used to deter, detect and/or make difficult the physical access to the communication lines carrying data, especially national security information. Approval authority, standards, and guidance for the design, installation, and maintenance for protective distribution system are stated in NSTISSI 7003. The requirements of this publication apply to U.S. government departments and agencies and further apply to contractors and vendors of these government departments and agencies. Hardened distribution protective distribution systems provide significant physical protection and are typically be implemented in three forms: Hardened Carrier protective distribution systems, alarmed carrier protective distribution systems and Continuously Viewed Carrier protective distribution systems.

In a hardened carrier protective distribution system the data cables are installed in a carrier constructed of electrical metallic tubing (electrical metallic tubing), ferrous conduit or pipe, or ridged sheet steel ducting. All of the connections of the tubing, conduit etc. in a hardened carrier system are permanently sealed around all surfaces with welds, epoxy or other such sealants. If the hardened carrier is buried under ground, to secure cables running between buildings for example, the carrier containing the cables is encased in concrete. The only way to access the data transmission lines is to break through the enclosing physical barrier, and doing so leaves signs of the intrusion which can be detected.

With a hardened carrier system, detection of attempts to intercept the transmitted data is accomplished by human inspections that are required to be performed periodically. Visual inspection requires that hardened carriers be installed below ceilings or above flooring so the physical structure enclosing the data transmission lines can be visually inspected to ensure that no intrusions have occurred. These periodic visual inspections (passive visual inspections) occur at a frequency dependent upon the level of threat to the environment, the security classification of the data being transmitted, and the access control to the area being inspected. Such inspections are costly, subject to inspection error which fails to detect intrusions, and limits the location of the data carrier.

Legacy alarmed carrier systems monitor the carrier containing the data transmission cables being protected. More advanced systems monitor ₜhe fibers within the carrier, or are made intrinsic to the carrier, with the cables being protected by turning those cables into sensors, which sensors detect intrusion attempts. But again, such systems are expensive to install, especially if the wire cables serve the dual purpose of acting as intrusion sensors while others transmit data.

Depending on the government organization, using an alarmed carrier protective distribution system in conjunction with suitable protection at cable junctions may, in some cases, allow for the elimination of the carrier systems altogether. In these instances, the cables being protected can be installed in existing conveyance mechanisms (wire basket, ladder rack) or installed in existing suspended cabling (on D-rings, J-Hooks, etc.).

A Continuously Viewed Carrier protective distribution system is one that is under continuous observation, 24 hours per day (including when operational). Viewing circuits may be grouped together to show several sections of the distribution system simultaneously, but should be separated from all non-continuously viewed circuits in order to ensure an open field of view of the needed areas. Standing orders typically include the requirement to investigate any viewed attempt to disturb the protective distribution system. Usually, appropriate security personnel are required to investigate the area of attempted penetration within 15 minutes of discovery. This type of hardened carrier is not used for Top Secret or special category information for non-U.S. Continuously viewing the data distribution system is costly and subject to human error.

Simple protective distribution systems are afforded a reduced level of physical security protection as compared to a Hardened Distribution protective distribution system. They use a simple carrier system (SCS) and the following means are acceptable under NSTISSI 7003: (1) the data cables should be installed in a carrier; (2) The carrier can be constructed of any material (e.g., wood, PVT, electrical metallic tubing, ferrous conduit); (3) the joints and access points should be secured and be controlled by personnel cleared to the highest level of data handled by the protective distribution system; and (4) the carrier is to be inspected in accordance with the requirements of NSTISSI 7003. But this approach also requires high costs, inspections, and manual inspections.

Increasing bandwidth and security demands in Local Area Networks (LAN) are leading to a shift form copper to fiber optic materials to carry the transmitted data. This increased bandwidth will also require Fiber-to-the-Desk (FTTD) as part of the required local area network. The term fiber-to-the-desk is used to describe the (usually) horizontal orientated cabling in the areas of data transmissions and telecommunication, which leads from the floor distributor to the outlets at the workplace on that floor, providing fiber-optic cable transmission to each desktop computer. In the standards ISO/IEC 11801 and EN 50173 this is the tertiary level.

In a secure fiber optic network application Tactical Local Area Network Encryption TACLANE) is a network encryption device developed by the National Security Agency (NSA) to provide network communications security on Internet Protocol (IP) and Asynchronous Transfer Mode (ATM) networks for the individual user or for enclaves of users at the same security level. Tactical local area network encryption allows users to communicate securely over legacy networks such as the Mobile Subscriber Equipment (MSE) packet network, Non-Secure Internet Protocol Router Network (NIPRINet), Secret Internet Protocol Router Network (SIPRNet), and emerging asynchronous transfer mode networks. The tactical local area network encryption limits the bandwidth of a secure fiber optic network to 1 to 10 Gb/s depending on the type network. Providing a secure alarmed protective fiber distribution system enables removing the tactical local area network encryption thereby allowing for 40 Gb/s network systems with that higher data rate provided directly to each desktop.

Approval authority, standards, and guidance for the design, installation, and maintenance for protective distribution system are provided by NSTISSI 7003 to U.S. government departments and agencies and their contractors.

The present invention uses a Protective Distribution System (PDS) solution that can provide Secure Physical Network Security Infrastructure Solution for Secure Passive Optical Network (SPON), Gigabit Passive Optical Network (GPON), and Fiber to the Desk (FTD) in Intrusion Detection of Optical Communication Systems (IDOCS) applications. The present invention can be customized to each application. The disclosed method and apparatus provide an end to end solution for Secure Passive Optical Networks (SPON), for Gigabit Passive Optical Network (GPON), and Fiber to the Desk (FTTD) is provided for Intrusion Detection of Optical Communication Systems (IDOCS) applications. This method and apparatus improves the deployment, management and protection of defense critical networks and C4ISR Facilities where open storage areas become a challenge.

While allowing the customization of Intrusion Detection of Optical Communication Systems (IDOCS)), the present method and apparatus uses fiber optic data transfer which provides improved technology over copper data transmission mechanisms where data protection is imperative and data speed necessary.

An alarmed carrier protective distribution system provides a desirable alternative to conducting human visual inspections and may be constructed to automate the inspection process through electronic monitoring with an alarm system. In an alarmed carrier protective distribution system, the carrier system is “alarmed” with specialized optical fibers deployed within the conduit for the purpose of sensing acoustic vibrations that usually occur when an intrusion is being attempted on the conduit in order to gain access to the cables. But such alarmed systems have been previously used only in main data transfer conduits between buildings or within computer centers. The present system significantly refines the application of the fiber optic alarms and applies the alarmed lines to junction boxes and user lock boxes.

An alarmed carrier protective distribution system offers several advantages over hardened carrier protective distribution system, including (1) providing continuous monitoring, day and night, throughout the year; (2) eliminating the requirement for periodic visual inspections; (3) allowing the carrier to be placed above the ceiling or below the floor or in other difficult to access locations, since passive visual inspections are not required; (4) eliminating the requirement for concrete encasement outdoors; (5) eliminating the need to lock down manhole covers; and (6) enabling rapid redeployment or modification for evolving network arrangements. While offering numerous advantages, such systems are expensive to install.

### BRIEF SUMMARY

A protected distributed fiber optic network is provided that allows the transmission of encrypted or non-encrypted data to user terminals at 40 Gbps rates while meeting current government security requirements. The protected distribution fiber optic network has alarmed fiber optic lines in the cables connecting a secured junction box to each of a plurality of secured user lock boxes. An outgoing alarm line, a return alarm line and a data line in each cable connect the junction box to each user box. The outgoing alarm line is looped to the return alarm line of the same cable and looped inside the user lock box. The return alarm line is looped to the outgoing alarm line of a different cable inside the junction box with repeated looping in the junction box and user box interconnecting a plurality of alarm lines passing through a plurality of user boxes. A detector detects an alarm signal in the interconnected alarm lines to trigger an intrusion alarm.

An alarmed fiber optic distribution network and method is provided which include fiber distribution panels and secure fiber optic secure junction boxes. Fiber optic jumpers or loopbacks allow for the alarming or un-alarming of fiber optic lines, which lines may comprise secret Internet protocol router networks or non-secure Internet protocol router networks for classified or unclassified data transmission used in conjunction with a protective distribution systems. The protective distribution system may have interlocking armored fiber optic cable attaching to secure junction boxes and attaching to secure lock boxes through the use of locking connect sleeves that are affixed to the interlocking armored fiber optic cables and also affixed to the boxes. The interlocking armored cable has the fiber optic lines inside the interlocking armored conduit and such construction is known in the art and not described in detail herein. Such interlocking armored cable is constructed to meet government security regulations suitable for use in transmitting secret data. Tampering with the cables containing the alarmed lines results in a signal transmission to a telecommunications room or other detector, resulting in notice of the tampering, which in turn may lead to various actions depending on the nature of the security and protocol for handling security threats or breaches.

A secure and alarmed protective fiber distribution system is provided that includes locking fiber distribution cabinets in a secure telecommunications room. The telecommunications room advantageously supports an alarming system and an optional alarm patching system. Rack mounted fiber distribution panels located in the telecommunications room connect fiber optic cables to new or to existing networks, and preferably provide the secure alarmed protective fiber distribution system. The interlocking armored fiber optic cable is run from the secure telecommunications room to various locations as desired to support classified and un-classified networks with an alarm point for one or more selected users. The interlocking armored fiber optic cable is fitted with connectors. The cables are run to secure junction boxes which clamp to the connectors on the cable. These secure junction box advantageously, but optionally, are constructed to meet all U.S. Air Force AF133-201V8 mandatory requirements for protective distribution systems, and to meet any other applicable security requirements.

The fiber optic cables extending from the secure junction box(es) may carry both the classified and un-classified lines in order to give the user the ability to make the entire network classified or any selected portions classified and alarmed or unclassified and not alarmed. From each secure junction box interlocking armored fiber optic cables extend to network users locations, with the cables having connectors that are clamped to a secure classified secure lock box. Depending on the type of network the secure lock box meets all U.S. Air Force AFI33-201V8 mandatory requirements for protective distribution systems or such other security requirements as are applicable. Depending on the type of network (i.e. passive optical network or Fiber to the Desk top fiber to the desk), a user device may be installed inside the secure lock box.

Two cores or lines in the interlocking armored fiber optic cable are used for alarming the various selected boxes and networks or selected portions of networks. Inside the secure junction box fiber jumpers are installed to provide an alarmed fiber optic line from the user fiber distribution panel to the alarm fiber distribution panel inside the telecommunications room so that the selected user terminals or selected networks are is connected to the alarming system. Within the secure junction box the alarming core or line will loop back the alarm signal to extend the signal to the selected user lock boxes or selected networks. The alarming core or line is not provided for non-secured lines or users or networks.

A protective system and method are disclosed that include fiber distribution panels and secure fiber optic secure junction boxes with the optional use of fiber optic jumpers or loopbacks to allow for the alarming or un-alarming of secret Internet protocol router networks or non-secure Internet protocol router networks to accommodate classified or unclassified data transmission when used in conjunction with a protective distribution system. The protective distribution system has pre-terminated interlocking armored fiber optic cable(s) attaching to secure junction boxes to secure lock boxes with the use of locking connect sleeves that are affixed to the interlocking armored fiber optic cable with epoxy.

The secure junction boxes and secure lock boxes include steel boxes with hidden hinge systems to avoid mechanical, in-line access to hinges. The boxes may have seams that are welded and ground to further inhibit access at the seams. A cable clamping system is preferably installed to accommodate the cable connect locking sleeves that are affixed to each cable. The cable clamp system may allow for per-terminated, pre-connectorized fiber optic interlocking armored cables to be installed in the box and held such that removal of an optical cable from the box is inhibited and that any such removal will result in visually perceptible damage. A Government Service Agency approved padlock may be used on each secure box for locking and inspection.

There is also provided a factory-manufactured, pre-terminated and pre-connectorized, fiber optic interlocking armored fiber optic cable having at least one pre-terminated and pre-connectorized access location for providing access to at least one pre-terminated and pre-connectorized interlocking armored fiber optic cable connector.

Depending on the application for either passive optical network or fiber to the desk topology, a simplex or duplex fiber may be used for the data transmission. In both topologies, duplex fiber may be used for alarming. In order ₜo maximize the use of the alarming ports, loopback connectors are used in the telecommunications room and/or within the secure junction box in order to extend the duplex alarming fiber to each secret Internet protocol router network user. An additional loopback may be installed within the user secure lockbox to return the alarming loop to the telecommunications room or secure junction box. During the installation the dB signal loss for distances and connections need to be considered and accommodated using known techniques to compensate for signal loss.

The present invention uses Intrusion Detection of Optical Communication Systems (IDOCS) and is especially useful in areas of a protective distribution system that cannot be visually monitored but still require protection at all times. Such an intrusion detection system requires minimal cost to install and operate when considering the rising costs of installing and maintaining a data encryption system, and the costs of other alternative protection systems. The benefit of using intrusion detection of optical communication systems over other alarmed carrier technology is that it monitors the same fiber or cable that required protection. Further, its COMSEC-specific development negates the false alarm issue that would result from the technology transfer of traditional fence line systems.

The Secure Passive Optical Network (SPON) solution of the present invention is based on the International Telecommunications Union-compliant Gigabit Passive Optical Network (GPON) technology. This solution provides connectivity for one or more of voice, data, video, and secure and non-secure local area networks, secure passive optical network seamlessly integrates analog and digital video, broadband data, and telephone services onto a common platform. It also provides a Layer 2 passive optical distribution system to end users. An Optical Line Terminal (OLT) at the data center provides the interconnection to the secure passive optical network system. Single mode fiber is then used to carry the optical signal to an Optical Network Terminal (ONT) at the user station that provides an intelligent managed demarcation point for network services.

The present invention advantageously uses Gigabit Passive Optical Networks (GPON) to provide a capacity boost in both the total bandwidth and bandwidth efficiency through the use of larger, variable-length packets in passive optical network technology. The gigabit passive optical network is standardized by the requirements of ITU-T G.984 (GPON). While those requirements permit several choices of bit rate, the industry has converged on 2.488 Gbps of downstream bandwidth, and 1.244 Gbps of upstream bandwidth. A Gigabit passive optical network Encapsulation Method (GEM) allows very efficient packaging of user traffic, with frame segmentation to allow for higher quality of service (QoS) for delay-sensitive traffic such as voice and video communications.

### BRIEF DESCRIPTION OF THE DRAWINGS

These and other advantages of the invention will be better understood in view of the following drawings and description, in which like numbers refer to like parts throughout, and in which:

FIG. 1 shows an implementation of the alarmed PDS as described, implementing point to multipoint architecture. In this drawing, a single channel of alarm system is able to monitor multiple cables.

FIG. 2 shows a schematic layout of a communications room and a fiber optic cable distribution system having secured and non-secured lines.

### DETAILED DESCRIPTION

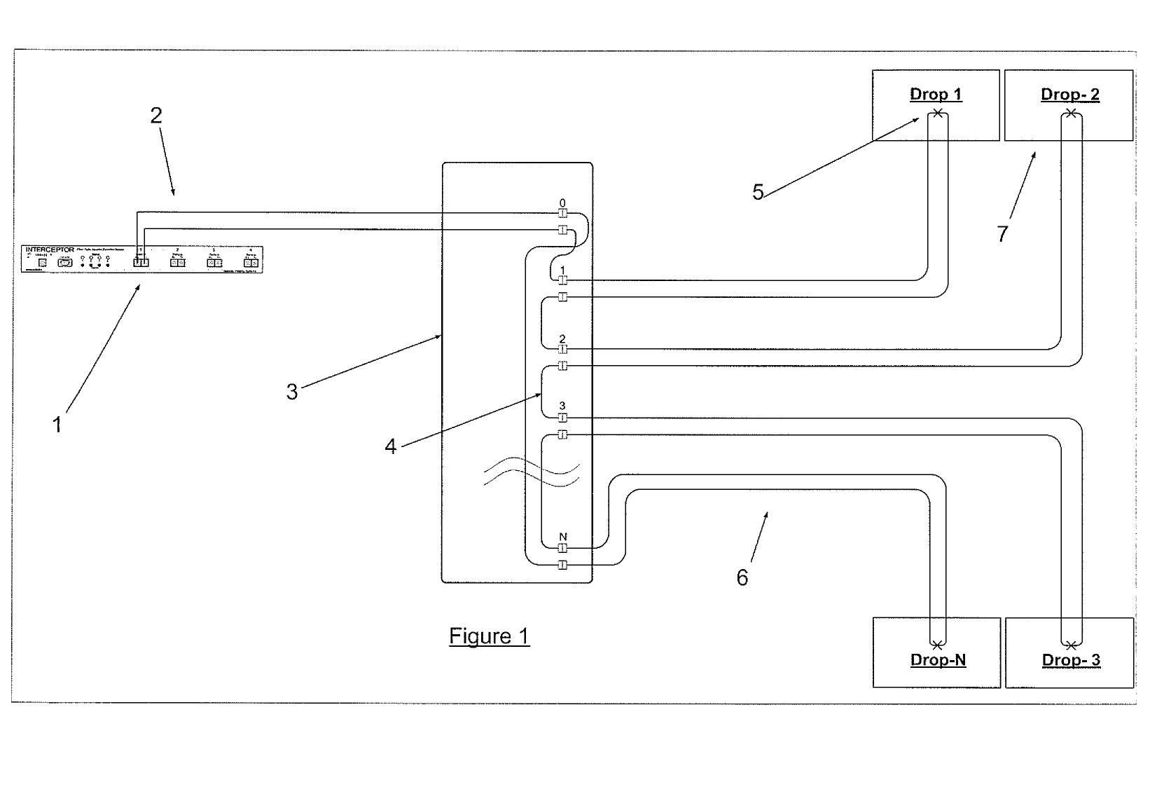

Referring to FIG. 1, a fiber optic distribution system alarming representation is shown. Alarm point 1 monitors one fiber or multiple fibers within a carrier such as a cable. The alarm fiber(s) are connected to a distribution mechanism 3, such as a patch panel. Within the mechanism 3, the alarm signal is distributed to one or multiple user boxes 7 by way of a point-to-multipoint (aka hub and spoke) architecture. The monitor signal is looped back to the remote locations by the loopback devices 4 within the distribution mechanism 3, and looped back from the remote locations 7 by remote loopback devices 5. The monitoring fibers 6 are present within conveyances such as cables or other carriers, preferably armoured cables. Within these cables where the monitor fibers 6 are present are collocated signal cables for carrying data either presently or in the future.

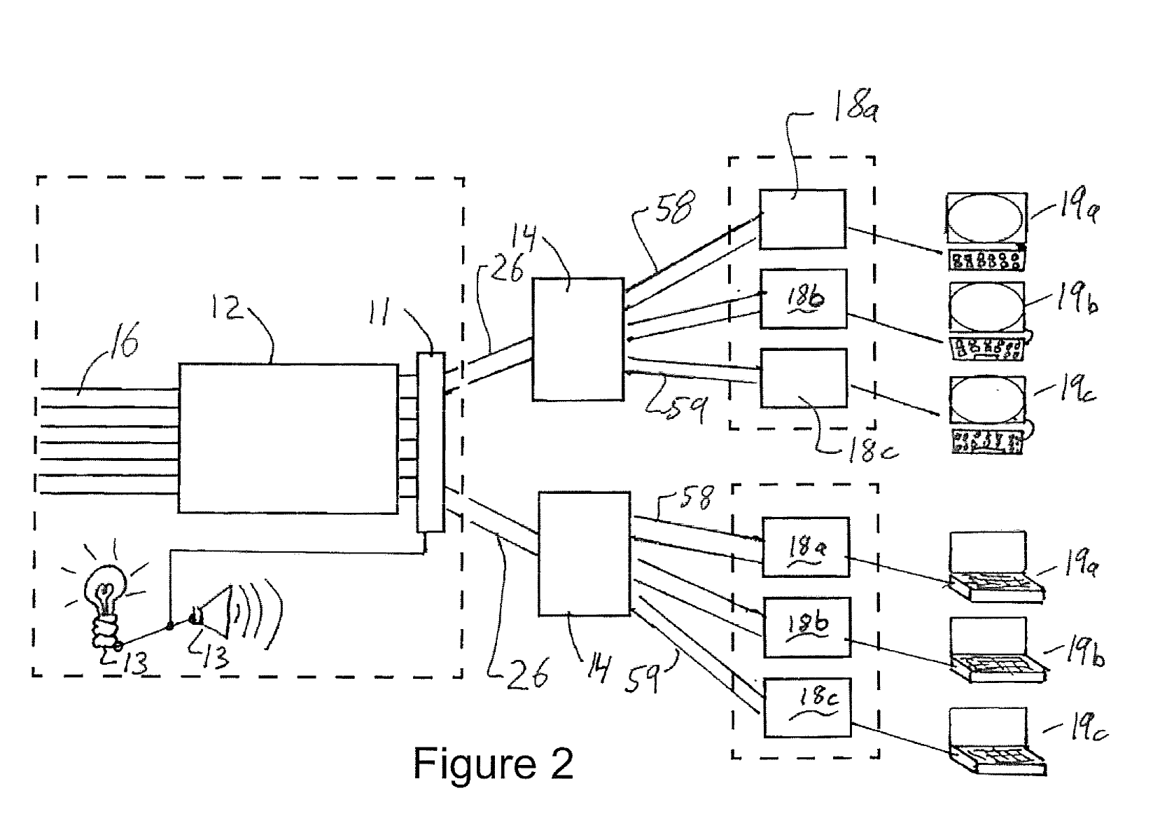

Referring to FIG. 2, a fiber optic distribution system 10 is shown that includes fiber distribution panels 12 preferably, but optionally located in a telecommunications center. The panel(s) 12 in the telecommunications center receive one or more fiber optic cables 16 bearing signals and routes various fiber optic cables 26 from the panel 12 to various locations schematically illustrated in FIG. 2 through various secured boxes 14, 18 and fiber optic cables 58, 59, to end user computer terminals 19. The routed data through cables 26 may come from other sources and need not be solely signals received from fiber optic cables 16.

The telecommunications room provides alarm sensors or detector 11 for detecting tampering or unauthorized access to selected cores or lines in any of a plurality of fiber optic cables 26. The detector 11 activates one or more of various signals 13, including audio signals, visual signals, or laser communication signals or telecommunication signals or electronic signals in response to appropriate signals or lack of signals from the selected alarmed cores or lines within cable(s) 26. The alarmed lines are discussed in more detail below.

The fiber optic cables 26 are advantageously routed from the panel 12 to one or more secure fiber optic junction boxes 14 which in turn route fiber optic cables 26 through further fiber optic lines (e.g., 58, 59) to one or more user lock boxes 18 connected to user computer terminals 19. If desired, the cables 26 may go directly from the telecommunications room to the user lock box 18. The junction boxes 14 may use fiber optic jumpers or loopbacks to allow for the alarming or un-alarming of secret Internet protocol router networks or non-secure Internet protocol router networks for classified or unclassified data transmission when used in conjunction with a protective distribution systems 10. The protective distribution system 10 uses interlocking armored fiber optic cables 26 attaching secure junction boxes 14 to secure lock boxes 18 with the use of locking connect sleeves that are affixed to the interlocking armored fiber optic cable 26 and the junction boxes 14. If a selected fiber optic line or core is to be secured, then as discussed later, cable 26 carrying that line has two additional alarm lines, one line carrying an alarm signal to one or more selected locations and one line returning an alarm signal from the one or more selected locations. Jumpers may loop back the alarming line to a selected plurality of locations and before connecting to the return alarm line thus forming a loop of interconnected alarm lines that end up back at detector 11 so that interference or tampering with the cables 26 or boxes 14, 18 results in an alarm detection by detector 11.

A fiber optic cable 26 experiences a signal loss that varies with the length of the cable and any bends in the cable. But signal loss is also caused by touching the cable, moving the cable and changing the light exposure of the cable. The fiber optic cables are sufficiently sensitive to changing conditions and physical contact that the cables experience a signal loss from acoustical vibrations. Thus, a person cutting the protective shielding around a fiber optic cable 26 to access the cable will cause a signal loss. Because light can travel very fast around a loop of fiber optic cable, any contact with a cable or movement of the cable or vibrations on the cable may be detected fast, and the location of the movement, contact, handling, etc. may be located along the length of the cable. The present invention thus uses pairs of fiber optic lines inside fiber optic cables 26 to alarm the cables and detect intrusions or attempts at intrusion. The detector 11 sends a signal through a fiber optic line and monitors the return signal to detect changes in the signal strength that reflect intrusions or cable movement, and that identifies the location of the intrusion along the fiber optic cable. Various detectors 11 may be used, with a detector named the Interceptor and sold by Network Integrity Systems in Hickory, N.C., believed suitable for use.

The cables 26 are preferably pre-terminated (i.e., connectors are attached by the manufacturer) where possible, and are advantageously armored by placing the cables inside a suitable carrier such as an interlocking armored cable, Electrical Metal Tubing (EMT), PVC pipe, or other suitable conduits meeting the security requirements of the particular application. Enclosing the fiber optic cables 26 in such armored conduits increases the sensitivity of the alarming lines because of the physical force needed to breach the conduits and reach the fiber optic lines, and because even the change in ambient light from a hole in the cable may be detected.

Referring to FIGS. 1 and 2, the cable 26 takes the form of one or more data feeds 26 from the telecommunications room which feed data to a secure junction box 14. For illustration, data cable 26a is a classified secret Internet protocol router network data and data cable feed 26b is an unclassified feed. The data feeds 26 are secured fiber optic cables. The junction boxes advantageously conform to U.S. Air Force AFI33-201V8 or other applicable specifications or regulations. The secure junction box 14 is configured to limit access to only authorized personnel, via use of various locking devices including keyed locks, padlocks, or electronic locks which may be unlocked by the authorized personnel. The junction boxes 14 are usually metal with no access other than through locked access doors, lids or panels with access controlled by the locking devices. Attempts at unauthorized entry to the junction box 14 will leave visual indications, or if electronically locked, the electronics may track time, date and personnel accessing the junction boxes 14 or may track attempts to access the junction box. Various electronic motion sensors or force sensors may be used to detect such attempts at access.

The data feed 26a may contain a plurality of lines that may transfer data of differing security levels, with each data transfer line receiving differing security protections. For illustration, feed line 26a includes secure data lines and secret data lines while unsecured feed line 26b includes non-secret and non-secure data lines

Each of the data lines is separately connected to a fiber optic patch panel that is preferably rack mounted to allow multiple panel support and many connections. The fiber optic patch panel connects the secure lines 26 to a fiber-to-the-premises (FTTP) network using passive optical network (PON) components. The patch panel 12 is advantageously located within or forms a wall of a secured box or facility so that access to the data lines are limited and require access through a tamper evident junction box. Thus, the rack mount fiber patch panel connects data feeds 26 to the new or existing optical line terminal or fiber to the desk network and could also be used for alarm patching. Both classified secret Internet protocol router networks 26a and un-classified non-secure Internet protocol router network 26 are connected to the rack mount fiber patch panel.

The alarming device is also connected to the rack mount fiber patch panel and could be jumper connected to any secure junction box 14. The cables 26 may be pre-terminated (i.e., connectors are attached by the manufacturer) and have interlocking armored fiber jumper cable to connect from the telecommunications room fiber patch panel. Color coded fiber optic connectors may be used to assign the type of connectivity.

The data feeds 26a, 26b may contain any number of fiber optic feeds, some of which are classified or secure or unclassified with the appropriate level of fiber optic line being physically routed to the appropriate user terminal. The fiber optic lines are preferably color coded, with black fiber optic lines or connectors indicating alarming feed for patching classified users, with red fiber optic connectors indicating classified secret Internet protocol router network feed for patching classified users and with green indicating un-classified non-secure Internet protocol router network feed from the telecommunications room. Appropriate fiber optic connectors on data lines provide for connection with other fiber optic lines. The connectors may be color coded as desired, preferably matching the wire colors, with red or black reflecting classified data line connectors and green reflecting non-classified data line connectors.

If the data transmission is interrupted, as by data tampering, theft, damage or other actions affecting the data transmission through the fiber optic cable, the interruption is detected at the telecommunications office by detector 11, which preferably both sends a signal through the outgoing alarm line and receives a signal from the return line in order to identify variations in the signal strength reflecting intrusions, intrusion attempts, and the location of such intrusions or attempts along the length of the alarm lines. This detection assumes that the data transmission of one line in a cable cannot be intercepted without disrupting the signal in the accompanying alarmed lines in the same cable. The jumpers are preferably 4 core pre-terminated and interlocked armored jumpers.

Referring again to FIG. 2, the fiber optic lines 26, 58 have opposing first and second ends extending from, between or through various ones of the boxes 14, 18 and distribution panels 12. The junction boxes 14 are typically the first boxes when the distribution system is viewed along the line of the data flowing through the fiber optic cables and lines within those cables. The user lock boxes 18 are usually the second boxes when the distribution system is viewed along the line of the data flowing through the fiber optic cables and lines within those cables. When the distribution system is viewed in the reverse direction, from the user lock box 18, then the user box is the first box and the junction box 14 is the second box, with the telecommunications room potentially containing further distribution boxes.

The interlocking armored fiber optic cables with the alarming lines and loopback features for each secured user allow the transmission of encrypted or non-encrypted data to user terminals at 40 Gbps rates while meeting current government security requirements. As the capacity of fiber optic cables to carry data increases, the data transfer rate will also increase. This provides a significant improvement over the ability to carry data over copper or other metal lines, while providing the security needed for classified and other secured data transmission. Further, the ability to secure the fiber optic transmission lines without encryption significantly simplifies the system and increases the data transfer rate and the actual speed with which data may be accessed and used by the computers 19 associated with each user lock box.

The above description is given by way of example, and not limitation. Given the above disclosure, one skilled in the art could devise variations that are within the scope and spirit of the invention disclosed herein, including various ways of routing the alarm lines along with the data transfer line that is to be protected against intrusion. Further, the various features of the embodiments disclosed herein can be used alone, or in varying combinations with each other and are not intended to be limited to the specific combination described herein. Thus, the scope of the claims is not to be limited by the illustrated embodiments.

1. A protective distribution system with alarmed, interlocking armored fiber optic cables, comprising:
a distribution panel in a secured location, at least a first interlocking armored fiber optic cable connected to the distribution and carrying a fiber optic outgoing alarm line and fiber optic return alarm line to transmit alarm signals, and least one data line that is transmitting data that may be encrypted; a secured junction box connected to the first fiber optic cable and having a plurality of interlocking armored, outgoing fiber optic cables each connected to the junction box at one end of each cable and connected to a different secured user lock box at the other end of the each cable so as to transmit data through the outgoing fiber optic cables;
at least a selected group of the plurality of outgoing fiber optic cables each having a fiber optic data transfer line transmitting the potentially encrypted data, and in addition the fiber optic outgoing alarm line and fiber optic return alarm line to transmit alarm signals, the selected group containing at least a first cable with a first outgoing alarm line and a first return alarm line and a last cable having a last outgoing alarm line and a last return alarm line; a mechanism such as a jumper, mechanical or optical splice, or other loopback device in each user lock box that is connected to the selected group of fiber optic cables, the said loopback device looping the outgoing alarm line to the return alarm line contained within the same cable connected to that user lock box so an alarm signal can pass from the outgoing line to the return line; at least one loopback device in the secured junction box connecting the return alarm line of the first cable within the selected group to the outgoing alarm line of another cable within the selected group to form a continuous fiber optic path of connected alarm lines through the secured user boxes associated with the first cable and said another cable until the last return alarm line is in fiber optic communication with the first outgoing alarm line;
and a detector in communication with the least the return alarm line which is in fiber optic communication with the return alarm line at the distribution panel, the detector configured to detect an alarm signal in the continuous fiber optic path of connected alarm lines.

2. The system of claim 1, wherein the secured user lock box contains at least one of an outgoing alarm line and a return alarm line that encircles a substantial portion of the user lock box.

3. The system of claim 1, wherein the secured user lock box is connected to a passive optical network.

4. The system of claim 1, further including a further plurality of cables in the selected group of cables which further plurality of cables pass through a wall of the junction box and also pass through a wall of the user lock box, comprising: at least one connector adhered to each cable in the further plurality of cables and adhered at the location where each cable passes through the wall of the junction box or the wall of the user lock box and connected to the wall at that location, each connector having a hole through which the cable to which the connector is adhered passes, each connector having two spaced apart and parallel flanges on at least two sides of the connector with a portion of each wall or a restraining portion connected to each wall fitting between the flanges of the connector to restrain movement of the connector along a length of the cable at the location of the connector.

5. The system of claim 1, wherein the alarm detector and control panel are in a telecommunications room.

6. The system of claim 1, wherein the secure junction box and secure user lock box meet all U.S. Air Force AF133-201V8 mandatory requirements for protective distribution systems.

7. The system of claim 1, wherein the distribution panel, junction box and all of the secured user lock boxes are on the same floor of a building.
